(19) United States
(12) Patent Application Publication
(10) Pub. No.: US 2007/0117626 A1
(43) Pub. Date: May 24, 2007

(54) Electronic game for computer or slot machine

(76) Inventor: Mario Castellari, Leonay (AU)

Correspondence Address: HOLLANDER LAW FIRM, P.L.C., SUITE 305, 10300 EATON PLACE, FAIRFAX, VA, 22030, US

(21) Appl. No.: 10/580,938

(22) PCT Filed: Nov. 28, 2004
(86) PCT No.: PCT/AU04/01649

§ 371 Date: Sep. 19, 2006

(30) Foreign Application Priority Data
Nov. 28, 2003 (AU) 2003906568

(51) Int. Cl. A63F 13/00

(52) U.S. Cl. 463/31

(57) ABSTRACT

An electronic game for play on a display screen wherein the game comprises; a display background, at least one three dimensional object presented on the display having at least one exposed surface defining a wall of the object; wherein, upon initiation of game play, the at least one three dimensional object morphs from three dimensions to form a two dimensional display of plurality of symbols.

### BACKGROUND

The present invention relates to electronic games of chance adapted for playing on a slot machine, computer or other communications device and more particularly relates to a game in which an array of symbols forming at least one pay line are created from an object of predetermined shape such as but not limited to a pentagon, cube or the like. More particularly the present invention discloses an electronic game which is initiated with a presentation of an object on a display and which is permanently or temporarily developed into a series of pay lines available on a wager by a player. The invention further provides an electronic game in which a predetermined three dimensional shaped object morphs into an array of symbols which form at least one pay line on which a player may make a wager, and wherein a win is determined with reference to pay/win tables.

### PRIOR ART

The electronic game industry has been expanding at a rapid rate due in particular to the rapid expansion of the internet and land based gaming and also the ease of access to such facilities as electronic games of chance that the internet makes widely accessible provides. This has spawned a growing demand for games for pure entertainment or for gaming as a result of which there has been a wide variety of games produced.

The challenge in the electronic game industry is to create games which are novel, will satisfy the community demand for entertainment and particularly in line readily accessible internet entertainment and with the requisite level of intellectual stimulation, free games, bet returns and consumer interest To attract consumers to play slot, computer and internet games, game creators have incorporated multiple pay lines, rewards, bonuses such as bonus and feature games and the like into the games. Bonuses and rewards may be awarded in a variety of ways such as but not limited to choosing symbols and betting on combinations which are then compared to a pay or win table. Alternatively, a win may be achieved with reference to one or more pay lines.

Other games exist which allow symbols to morph from a two dimensional state to a three dimensional state during game play. In games of his type the symbols carriers remain in tact and spin in rows or columns. Games exist where symbols carriers morph during spinning from two dimensional rows or columns to a transient three dimensional display. In these arrangements the spinning does not disrupt the symbol carrier abutments whether they be rows or columns. Thus, if a two dimensional row is spun, there is a conversion to three dimensions of the row carrier symbols but there is no disconnection between symbols or folding and unfolding and the original geometric shape formed by the row is retained at the completion of the spinning.

### INVENTION

The present invention seeks to provide a novel alternative to the known electronic games of chance and which is suitable for playing on a computer, the internet, communications device and/or slot machine including gaming machines. More particularly the invention provides an interactive electronic game in which a participant may interact by placing wagers on a random outcome of the game for entertainment or material gain. The game in all its forms provides a player with a wide variety of options within the game framework and may be played on a personal computer, gaming or slot machine or other communications device capable of accessing the internet.

More particularly the invention provides an electronic novelty game of chance in which a three dimensional object which may be of any geometric shape is presented to a player. The object may initially have symbols on exposed surfaces or concealed within the object When a player initiates game play, the three dimensional object shape carrying the symbols morphs (change) from three dimensions to a two dimensional array of pay lines. The number of pay lines may be determined by the number of faces initially presented by the three dimensional object prior to spinning morphing to two dimensions.

In one broad form the present invention comprises; an electronic game for interactive play on a screen of a slot machine, gaming machine, computer or the like wherein the game comprises a display including a three dimensional object having a plurality of icons and/or, symbols and/or, numbers or the like, displayed on a surface of said object; wherein upon initiation of the game, said object morphs into rows and/or columns to form a predetermined two dimensional shaped display such as a square, rectangle, triangle or irregular shape, wherein each said rows includes one or more said symbols, letters, icons, numbers, whereupon, a player may make a wager on the outcome of a number of pay lines presented in two dimensions one or more said pay lines.

Said one or more columns and/or rows are created in a generally vertical or horizontal plane responsive to morphing from the three dimensional object to the two dimensional rows and columns.

At the completion of morphing a player is presented with a random array of symbols or combination of said symbols, letters, numbers, icons, the combination being compared to a predetermined pay or win table or data base to determine the outcome of said game.

According to one embodiment, the two dimensional screen display comprises one horizontal row and one vertical row. In another embodiment, the screen display comprises at least two horizontal rows and at least one vertical rows with each row comprising three symbols and/or numbers. A random display of symbols and/or numbers results from the morphing of said three dimensional object.

In its broadest form the present invention comprises:

an electronic game for play on a display screen wherein the game comprises;

a display background,

at least one three dimensional object presented on the display having at least one exposed surface defining a wall of the object;

wherein, upon initiation of game play, said at least one three dimensional object morphs from three dimensions to form a two dimensional display of plurality of symbols.

Preferably the three dimensional object has in addition to the at least one exposed surface at least one hidden inner surface. According to one embodiment, each said symbol of the two dimensional display is displayed on a carrier background which formed at least part of the hidden inner or outer surface of said three dimensional object.

Preferably, said morphing involves fragmentation of inner and/or outer surfaces of the three dimensional object and reformation of the surfaces in a two dimensional array of symbol carriers. The fragmentation of the three dimensional objects forms discrete elements each having a surface which bears at least one symbol; wherein the discrete elements assemble to form at least one row of symbol carriers.

Preferably, a surface of each discrete element forms part of the inner surface of the three dimensional object and an opposite surface of each discrete element forms part of an external surface of the object. Preferably, the total surface area of the symbol carriers displayed in two dimensions is equal the total surface area of either an internal or external surface of the at least one three dimensional object The symbol carriers remain joined during fragmentation of the three dimensional object into two dimensions. Preferably, the display of the symbols on the symbol carriers and the symbols carriers is random, wherein a row of the two dimensional display may be formed by a plurality of abutting symbol carriers. A symbol is displayed by superimposition over the symbol carrier. Each three dimensional object includes a plurality of hidden internal surfaces.

Wherein the morphing of the three dimensional object involves the steps of fragmentation of the elements, random motion of the fragmented elements then assembly of the elements randomly into two dimensional rows and columns. The at least one row or column is formed from a plurality of said elements and the two dimensional display includes at least one pay line taken along at least one predetermined path along the elements which comprise the two dimensional display.

A player may make a wager on the outcome of a number of pay lines presented in two dimensions prior to said morphing of the object. A shape of each discrete element may be selected from one or more of a square, rectangle, triangle ovoid circle, polygon. The symbols are selected from letters, icons, numbers, figures, caricatures, animals, geometric shapes, objects. The game is playable on a computer, slot machine, gaming machine.

At the completion of morphing, a player is presented with a random two dimensional array of symbols or combination of said symbols, letters, numbers, icons; the combination along one or more said pay lines being compared to a predetermined pay table to determine an outcome of said game.

In another broad form the present invention comprises:

an electronic game capable of display on a screen of a slot machine, computer or the like;

the game comprising a screen display initially comprising at least one object in three dimensions each having at least one exposed face each bearing a game symbol, icon number/s or the like;

wherein, when a player initiates game play the at least one three dimensional object morphs during which the three dimensional object fragments into discrete elements which reassemble to be displayed as a two dimensional array of rows and columns. Preferably, the three dimensional object is a polyhedron having multiple exposed faces.

Upon morphing of the three dimensional object, all faces of said three dimensional object/s are displayed on the screen in two dimensions forming said rows and columns.

In another broad form the present invention comprises:

an interactive game for playing on an electronic device such as a computer, gaming machine or the like: the game comprising a screen which displays a three dimensional shape having a plurality of faces, wherein the three dimensional shape morphs into a two dimensional display on the screen display, such that all said faces are displayed on the second screen display in a plurality of parallel and/or intersecting rows and columns;

wherein each said faces include at least one symbol; whereupon an outcome of the game may be determined by a comparison between a random display of symbols, with a pay or win table; wherein a participant may make a wager on the random outcome. The game comprises a screen display initially comprising at least one object displayed in three dimensions having at least two exposed faces each bearing game symbols, icons numbers or the like;

the method comprises the steps of

a) initiating play of a primary game
b) allowing a player to wager on an outcome of the game
c) causing the three dimensional object to morph so that all faces of said three dimensional object fragment then re assemble on the display screen in two dimensions;
d) forming at least one pay line which traverses a path of symbols;
e) awarding a player according to a comparison between the symbols traversed by said at least one pay line and the predetermined pay table.

In another broad form of a method aspect the present invention comprises:

a method of playing an electronic game, comprising the steps of

a) providing a screen display comprising at least one three dimensional object having a plurality of faces;
b) making a wager on an outcome of the game;
c) effecting a spin command to cause one or more said objects to morph by fragmentation of each said faces of said at least one object thereby forming rows and/or columns bearing-symbols, one on each face,
d) providing at least one pay line for a player from traversing symbols on said rows and/or columns formed by said morphing and
e) comparing the symbols traversed by said at least one pay line with a predetermined pay table.

In another broad form of a method aspect the present invention comprises:

a method of playing an electronic game on a slot machine gaming machine, or computer, wherein the method comprises the steps of,

a) presenting on a screen in three dimensions an object having a plurality of faces which each include a symbol, icon, number or the like;
b) making a wager on an outcome of the game;
c) effecting a spin command to cause one or more said objects responsive to said spin command to re orient the faces to form a plurality of two dimensional rows and for columns formed by the symbols such that the number of symbols in the rows and columns corresponds to a number of hidden and/or exposed faces on a corresponding three dimensional object;
d) comparing symbol combinations traversed by pay lines with a pay table to determine an award to a player on the game outcome.

In another broad form the present in comprises:

A method of playing an electronic game on a slot machine gaming machine, or computer, wherein the method comprises the steps of,
a) presenting on a screen in three dimensions an object having a plurality of faces which each include a symbol, icon, number or the like;
b) making a wager on an outcome of the game;
c) effecting a spin command to cause one or more said objects responsive to said spin command to re orient the faces to form a plurality of two dimensional rows and/or columns formed by the symbols such that the number of symbols in the rows and columns corresponds to a number of hidden and/or exposed faces on a corresponding three dimensional object;
d) comparing symbol combinations traversed by pay lines with a pay table to determine an award to a player on the game outcome.

In a broad form of the method aspect the present invention comprises;

a method for playing an electronic game displayed on a screen of a slot machine, computer or the like; the game comprising a screen display initially comprising at least one object displayed in three dimensions having at least two exposed faces each bearing game symbols, icons numbers or the like;

the method comprising the steps of

a) initiating play of a primary game
b) allowing a player to wager on an outcome of the game
c) causing the three dimensional object to morph so that all faces of said three dimensional object are displayed on the screen in two dimensions;
d) awarding a result according to a predetermined pay table.

A method of playing an electronic game, comprising the steps of:
a) providing a screen display comprising at least one three dimensional object having a plurality of faces;
b) making a wager on an outcome,
c) effecting a spin command to cause one or more said objects to alter its shape to an extent that each said at least one object forms rows and/or columns;
d) providing at least one pay line for a player from said rows and/or columns formed by a changing state of said at least one object

According to a preferred embodiment, the rows and/or columns are displayed in two dimensions and represent a developed view of the corresponding three dimensional object in the initial display.

After the spin command which sets in train a morphing of the at least one three dimensional objects to the two dimensional rows and/or columns symbols, icons, numbers or the like are randomly displayed in two dimensions.

At the conclusion of said spinning to form the rows and/or columns a player wager is compared to a predetermined pay or win table or data base and a payout is determined depending upon a comparison between the random symbol, icon or number or a combination of said symbols, numbers, icons, and the pay table to determine a game result.

In another broad form of the method aspect, the present invention comprises;

a method of playing an electronic game on a slot machine gaming machine, computer or the like, wherein the method comprises the steps of,

a) presenting on a screen in three dimensions an object having a plurality of faces which each include a symbol, icon, number or the like;
b) making a wager on an outcome of the came;
c) effecting a spin command to cause one or more said objects responsive to said spin command to form a plurality of two dimensional rows and/or columns;
d) allowing said objects to spin to a halt such that rows and columns of random symbols, icons, numbers or the like are displayed in two dimensions such that the number of symbols in the rows and columns corresponds to the number of faces (hidden or exposed) on a corresponding three dimensional object.

In a broad form of an apparatus aspect the present invention comprises;

an electronic game displayed on a screen of a slot machine, computer or the like; the game comprising a screen display initially comprising at least one object in three dimensions each having at least two exposed faces each bearing a game symbol, icon number is or the like;

wherein, when a player initiates game play the at least one three dimensional object morphs so that all faces of said three dimensional object/s are displayed on the screen in two dimensions.

According to a preferred embodiment a player receives an award according to a predetermined pay table after a wager on said at least one three dimensional object.

According to a preferred embodiment, the faces of the three dimensional object/s are displayed in at least one row and/or columns.

According to a preferred embodiment a plurality of icons, symbols, numbers or the like, are displayed in a plurality of faces which collectively form a three dimensional object displayed on a screen For example one 3D object might be a pentagon and another a cube. Each 3D object has the capacity to morph or develop into rows and columns in two dimensions wherein said rows and columns include one or more said symbols, icons, numbers, wherein each said icons, symbols, numbers in the rows or columns provide pay lines for a player.

According to a preferred embodiment, when a spin command is executed, each symbol, icon is initially provided on a three dimensional shape such as but not limited to a cube, polygon or the like and when a spin has completed each of the three dimensional shapes assume a two dimensional developed configuration displaying symbols on each face of the object.

In another broad form the present invention comprises;

an interactive electronic game for display on a screen of a slot machine, gaming machine or computer, the game display comprising in three dimensions at least one object which when a spin command is executed by a player morph into 2D rows and/or columns formed by faces of the objects, each said faces carrying randomly displayed symbols, icons, numbers or the like.

When spinning stops symbols are displayed randomly and may be compared to a pay or win table or data base thereby providing an outcome for said game.

In another broad form the present invention comprises:

an interactive game for playing on an electronic device such as a computer, gaming machine or the like: the game comprising a first screen which displays a three dimensional shape having a plurality of concealed and revealed faces, wherein the three dimensional shape morphs into a two dimensional display on a second screen, such that all said concealed and revealed faces are displayed on the second screen display in a plurality of parallel and/or intersecting rows and columns; wherein each said faces include at least one symbol, icon, letter or numbers disposed in; whereupon an outcome of the game may be determined by a comparison between a random display of symbols, icons, letters or numbers of said random display with a pay or win table; wherein a participant may make a wager on the random outcome.

In another broad form the present invention comprises:

an electronic game for playing on an electronic device such as a slot machine, computer or the like:

the game comprising three dimensional objects which are capable of morphing into two dimensional rows and/or columns upon execution of a spin command.

The three dimensional objects may morph into a plurality of parallel and/or intersecting rows and columns; wherein the rows and columns are made up of faces of the three dimensional objects. A participant may make a wager on a random outcome according to pay lines formed when the three dimensional objects morph into two dimensions.

According to one embodiment, the game described herein may be adapted as a multi hand game option in which three dimensional objects which are capable of morphing into two dimensional rows and/or columns upon execution of a spin command.

In another broad form the present invention comprises:

an electronic game for play on a display screen wherein the game comprises;

a display background,

a two dimensional display of discrete elements each having a surface capable of holding a symbol;

means associated with the game to initiate game play, wherein, when game play is initiated, the two dimensional display of discrete elements morph to cause at least one three dimensional object to be presented on the display having at least one exposed surface defining a wall of the object;

wherein, during game play, said at least one three dimensional object morphs from three dimensions to form a two dimensional display of plurality of symbols.

Preferably each said symbol of the two dimensional display is displayed on a symbol carrier wherein each symbol carrier forms at least part of said at least one three dimensional object.

### BRIEF DESCRIPTION OF TIRE DRAWINGS

The present invention will now be described in more detail according to preferred but non limiting embodiment and with reference to the accompanying illustrations wherein:

FIG. 1 shows an elevation view of a screen display of a developed cube having six displayed faces and letter symbols;

FIG. 2 shows an elevation view of a screen display of a developed pentagon having 17 displayed faces and letter symbols;

FIG. 3 shows a two dimensional array comprising symbol carriers forming rows and columns.

FIG. 4 shows three dimensional objects formed from symbol carriers of the two dimensional array of FIG. 3 according to one embodiment.

FIG. 5 shows a two dimensional array similar to that of FIG. 3 but comprising a new random array of symbols.

### DETAILED DESCRIPTION

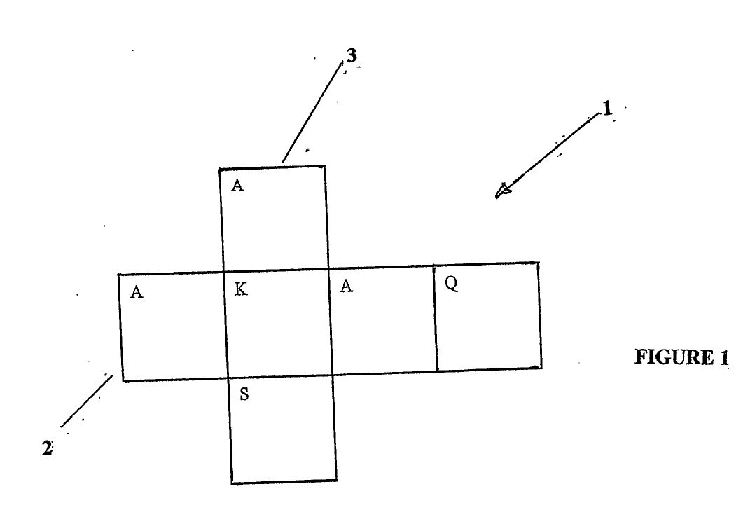

Referring to FIG. 1 there is shown a two dimensional display 1 comprising a first row 2, and intersecting first column 3. Row 2 is formed from panels AKAQ and column is formed from panels AKS. Each panel represents a face of a three dimensional cube which develops or unfolds to form display 1 upon initiation of a game play.

Each of panels AKAQ and AKS include a variety of game symbols, numbers, icons or the like which are randomly displayed after initiation of game play. In the example shown in FIG. 1 the game commences with a cube displayed on an electronic display.

This is an interactive alternative to the known electronic games of chance and is suitable for playing on a computer, the internet, communications device and/or slot machine including gaming machines. A game participant may interact by placing wagers on a random outcome of the game for entertainment or material gain. The game in all its forms provides a player with a wide variety of options within the game framework and may be played on a personal computer, gaming or slot machine or other communications device capable of accessing the internet The game of chance commences with a three dimensional object which is preferably cubic, prismic or polygonal. In fact virtually any three dimensional shape can be presented to a player to initiate the game. The initial display may include one or a plurality of three dimensional objects. The selected three dimensional object displays symbols, icons numbers or the like on exposed or concealed surfaces within the object. In the case of a cube three surfaces would normally be exposed to view and three concealed from view. When a player initiates game play, the three dimensional object shape carrying the symbols morphs (change) from three dimensions to the two dimensional display as shown in FIG. 1. The number of pay lines may be determined by the number of faces presented by the three dimensional object prior to spinning morphing to two dimensions. In the case of the embodiment of FIG. 1 there are potentially one, two, three or four pay lines namely: AAAQ, AKAQ AKS and ASAQ.

The columns and rows are created in a generally vertical or horizontal plane responsive to morphing from the three dimensional object. At the completion of morphing a player is presented with the FIG. 1 display. A random display of symbols icons, numbers or the like is compared to a predetermined pay or win table or data base to determine the outcome of said game.

According to the method aspect an electronic game is displayed on a screen of a slot machine, computer or the like. At least one object displayed in three dimensions will have at least two exposed faces each bearing game symbols, icons numbers or the like. The player adopts the following steps.
a) the player initiates play of a primary game,
b) the player may make a wager on an outcome of the game,
c) playing the game causes the three dimensional object to morph so that all faces of the three dimensional object are displayed on the screen in two dimensions;
d) awarding a result according to a predetermined pay table.

According to a preferred embodiment, the rows and/or columns formed when the three dimensional object morphs are displayed in two dimensions and represent a developed view of the corresponding three dimensional object in the initial display.

At the conclusion of said spinning to form the rows and/or columns a player wager is compared to a predetermined pay or win table or data base and a payout is determined depending upon a comparison between the random symbol, icon or number or a combination of said symbols, numbers, icons, and the pay table to determine a game result.

According to a preferred embodiment a plurality of icons, symbols, numbers or the like, are displayed in a plurality of faces which collectively form a three dimensional object displayed on a screen. For example one 3D object might be a pentagon and another a cube. Each 3D object has the capacity to morph or develop into rows and columns in two dimensions wherein said rows and columns include one or more said symbols, icons, numbers, wherein each said icons, symbols, numbers in the rows or columns provide pay lines for a player.

According to a preferred embodiment, when a spin command is executed, each symbol, icon is initially provided on a three dimensional shape such as but not limited to a cube, polygon or the like and when a spin has completed each of the three dimensional shapes assume a two dimensional developed configuration displaying symbols on each face of the object.

A player may elect to play each row or all rows or row/column combinations.

Although FIG. 1 shows a display having one horizontal row and one vertical column, it will he appreciated by those skilled in the art that a display of potentially any number of combined rows and columns can be employed with the only limitation being the size of the screen display and the nature of the three dimensional object required to produce the display.

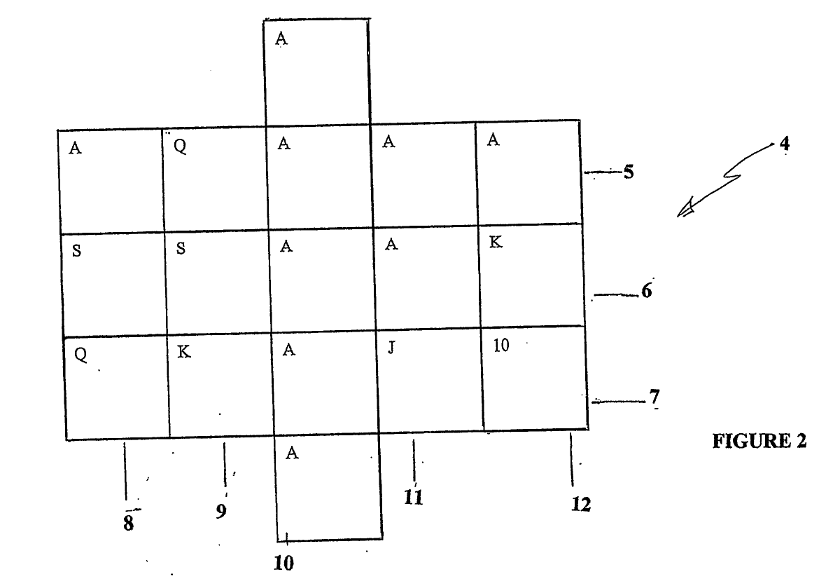

FIG. 2 shows a game screen display 4 comprising three rows 5, 6 and 7 and five columns, 8, 9, 10, 11 and 12 according to one embodiment of the invention. This provides a 3×5 grid for slot machines which could slide across all vertical columns to re evaluate pay possibilities. Game screen display 4 is characterized by the fact that rows 5, 6 and 7 may form pay lines. Typical pay lines would be AQAAA (including upper column element), AQAAA, SSAAK, AQKAJ10 and AKAJ10 (including lower column element).

In addition to use on slot machines, the game may be adapted for personal computers via the internet or for individual play.

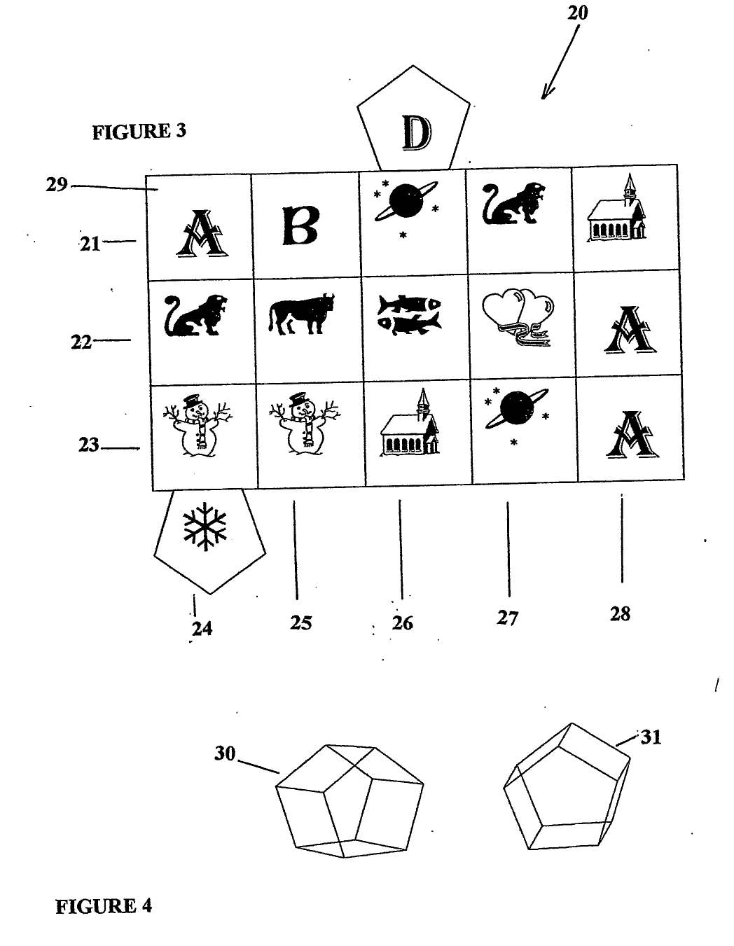

FIG. 3 shows a two dimensional array comprising symbol carriers forming rows and columns.

Referring to the example of FIG. 3 there is shown a two dimensional display 20 comprising symbol rows 21, 22 and 23. The display also includes five columns 24, 25, 26, 27 and 28. Rows 21-23 each contain five symbols. Columns 24 and 26 include four symbols and columns 25, 27 and 28 comprise three symbols. Each symbol is held by a background carrier For instance the first symbol A in row 21 and column 24 is carried by symbol carrier 29. Thus in the same way all symbols in the rows and columns are carried by a background symbol carrier. According to one embodiment, each carrier forms part of a face of a three dimensional object In the case where a screen display such as display 20 is presented to a player at the commencement of game play, upon initiation of game play, the two dimensional display of symbols in FIG. 3 morphs to form a three dimensional object 30 such as that shown in FIG. 4: The number of symbol carriers may equal the number of faces on the three dimensional object 30. Alternatively, the number of symbol carriers may not be the same as the number of faces on the three dimensional object 30. In a further alternative, the initial two dimensional display may morph to form more than one three dimensional object so that the display 20 morphs to form objects 30 and 31 as shown in FIG. 4. FIG. 4 shows three dimensional objects formed from symbol carriers of the two dimensional array of FIG. 3.

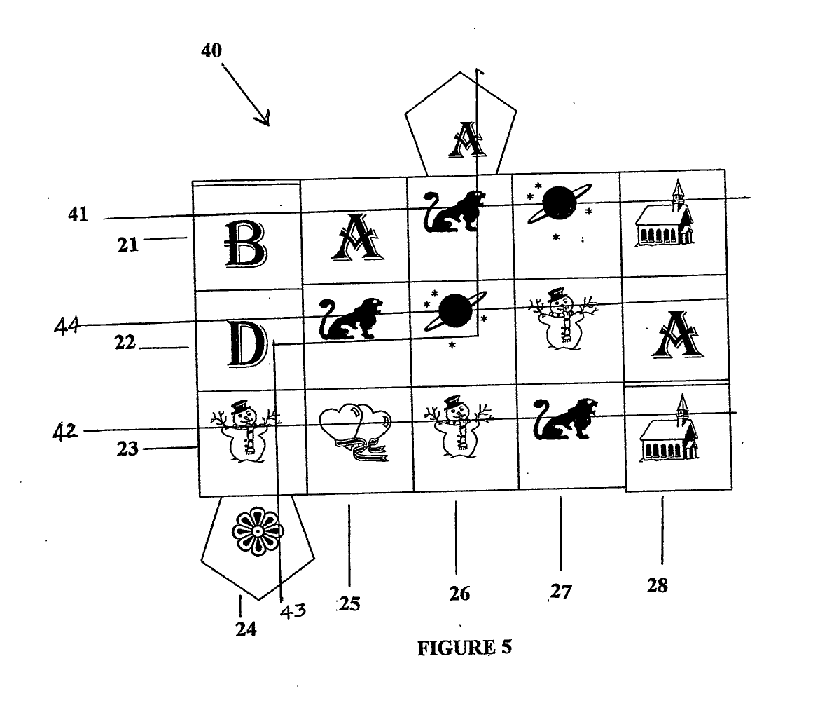

Display of either three dimensional object 30 (or according to the alternative embodiment) objects 30 and 31, is transient and leads to further morphing of the one or multiple three dimensional objects until a further two dimensional random display 40 of symbols. FIG. 5 shows a two dimensional array similar to that of FIG. 3 but comprising a new random array of symbols.

The symbols may either be a random rearrangement of the symbols of FIG. 3 or another random arrangement from a pool of symbols. As with FIG. 3 two random dimensional display 40 comprises symbol rows 21, 22 and 23. The display also includes five columns 24, 25, 26, 27 and 28. Rows 21-23 each contain five symbols. Columns 24 and 26 include four symbols and columns 25, 27 and 28 comprise three symbols. Each symbol is held by a background carrier. For instance the first symbol B in row 21 and column 24 is carried by symbol carrier 29. Thus in the same way all symbols in the rows and columns are carried by a background symbol carrier. A player may wager or bet on the outcome of the random display 40. This may be achieved by comparing win lines such as lines 41, 42, 43 and 44 to a pay table.

According to the embodiment of FIGS. 3-5, when a player initiates game play, the two dimensional display carrying the symbols morphs (change) from two dimensions to the three dimensional object or objects 30 and/or 31 as shown in FIG. 4. The three dimensional objects morph (change) from three dimensions to the two dimensional display as shown in FIG. 5. The number of pay lines may be determined by the number of faces presented by the three dimensional object prior to spinning morphing to two dimensions. Alternatively the player may bet on pay lines from the initial two dimensional display of FIG. 3. There are potentially a plurality of pay lines which may traverse columns or rows or a combination of both.

A random display of symbols icons, numbers or the like appearing along the pay lines is compared to a predetermined pay or win table or data base to determine the outcome of said game.

The primary object of the game is to match symbols on the display following a play, with a pay or win table. Following a play, the player receives on the display a random fall of numbers or symbols which pay according to the pay table. According to one embodiment, the initial screen which is displayed to the player comprises either a two dimensional array of rows and columns of symbols or a three dimensional object bearing symbols, icons and/or numbers arranged on the surfaces of the object The payout table may be based on a result which allows predetermined symbols and/or numbers to be displayed in any position on the face of the final two dimensional display and in any row or column.

The number of symbols or numbers on the display will determine the statistical outcome of the game and the number of like symbols or numbers of the same kind will determine the win and/or payout Preferably the outcome of a game is entirely random.

According to an alternative embodiment, the typical game may have an additional feature whereby a predetermined event during an initial play will trigger a second game state and possibly a number of subsequent game states.

The games may be adapted as a skills game for one or multiple players at the same or remote locations. Also the game may be adapted for multi hand displays. According to one embodiment there may be provided for instance, in a first screen display a first plurality of three dimensional symbols which either individually or collectively morph into two dimensional developed view of each three dimensional symbol.

It will be recognized by persons skilled in the art that numerous variations and modifications may be made to the invention as broadly described herein without departing from the spirit and scope of the invention.

1. An electronic game for play on a display screen wherein the game comprises;
a display background,
at least one three dimensional object presented on the display having at least one exposed surface defining a wall of the object;
wherein, upon initiation of game play, said at least one three dimensional object morphs from three dimensions to form a two dimensional display of plurality of symbols.

2. An electronic game according to claim 1 wherein the three dimensional object has in addition to the at least one exposed surface at least one hidden inner surface.

3. An electronic game according to claim 2 wherein each said symbol of the two dimensional display is displayed on a carrier background which form at least part of the hidden inner or outer surface of said three dimensional object.

4. An electronic game according to claim 3 wherein said morphing involves fragmentation of inner and/or outer surfaces of the three dimensional object and reformation of said surfaces in a two dimensional array of symbol carriers.

5. An electronic game according to claim 4 wherein said fragmentation of the three dimensional objects forms discrete elements each having a surface which bears at least one symbol.

6. An electronic game according to claim 5 wherein the discrete elements assemble to form at least one row of symbol carriers.

7. An electronic game according to claim 6 wherein a surface of each discrete element forms part of said an inner surface of the three dimensional object and an opposite surface of each discrete element forms part of an external surface of the object.

8. An electronic game according to claim 7 wherein, the total surface area of the symbol carriers displayed in two dimensions is equal the total surface area of either an internal or external surface of the at least one three dimensional object.

9. An electronic game according to claim 8 wherein the symbol carriers remain joined during fragmentation of the three dimensional object into two dimensions.

10. An electronic game according to claim 9 wherein the display of the symbols on the symbol carriers and the symbols carriers is random.

11. An electronic game according to claim 10 wherein a row of the two dimensional display may be formed by a plurality of abutting symbol carriers.

12. An electronic game according to claim 11 wherein a symbol is displayed by superimposition over the symbol carrier.

13. An electronic game according to claim 11 wherein there are a plurality of hidden internal surfaces in each said three dimensional object.

14. An electronic game according to claim 13 wherein the morphing of the three dimensional object involves said fragmentation of the elements, random motion of the fragmented elements then assembly of the elements randomly into two dimensional rows and columns.

15. An electronic game according to claim 14 wherein, at least one row or column is formed from a plurality of said elements.

16. An electronic game according to claim 15 wherein, the two dimensional display includes at least one pay line taken along at least one predetermined path along the elements which comprise said two dimensional display.

17. An electronic game according to claim 16 whereupon, a player may make a wager on the outcome of a number of pay lines presented in two dimensions prior to said morphing of the object.

18. An electronic game according to claim 17 wherein a shape of each discrete element is selected from one or more of a square, rectangle, triangle ovoid circle, polygon.

19. An electronic game according to claim 18 wherein the symbols are selected from letters, icons, numbers, figures, caricatures, animals, geometric shapes, objects.

20. An electronic game according to claim 19 wherein, the game is playable on a computer, slot machine, gaming machine.

21. An electronic game according to claim 1 wherein at the completion of morphing, a player is presented with a random two dimensional array of symbols or combination of said symbols, letters, numbers, icons; the combination along one or more said pay lines being compared to a predetermined pay table to determine an outcome of said game.

22. An electronic game capable of display on a screen of a slot machine, computer or the like; the game comprising a screen display initially comprising at least one object in three dimensions each having at least one exposed face each bearing a game symbol, icon number/s or the like;
wherein, when a player initiates game play the at least one three dimensional object morphs during which the three dimensional object fragments into discrete elements which reassemble to be displayed as a two dimensional array of rows and columns.

23. An electronic game according to claim 1 wherein the three dimensional object is a polyhedron having multiple exposed faces.

24. An electronic game according to claim 23 wherein upon morphing of the three dimensional object all faces of said three dimensional objects are displayed on the screen in two dimensions forming said rows and columns.

25. An interactive game for playing on an electronic device such as a computer, gaming machine or the like: the game comprising a screen which displays a three dimensional shape having a plurality of faces, wherein the three dimensional shape morphs into a two dimensional display on the screen display, such that all said faces are displayed on the second screen display in a plurality of parallel and/or intersecting rows and columns; wherein each said faces include at least one symbol; whereupon an outcome of the game may be determined by a comparison between a random display of symbols, with a pay or win table; wherein a participant may make a wager on the random outcome.

26. An interactive electronic game according to claim 25 wherein the at least one three dimensional object is initially presented in an opened out two dimensional array wherein the array comprises discrete symbol carriers which have a surface on which a symbol is displayed.

27. An interactive game according to claim 26 wherein the discrete symbol carriers combine to form the three dimensional object.

28. A method for playing an electronic game displayed on a screen of a slot machine, computer or the like; the game comprising a screen display initially comprising at least one object displayed in three dimensions having at least two exposed faces each bearing game symbols, icons numbers or the like; the method comprising the steps of
a) initiating play of a primary game;
b) allowing a player to wager on an outcome of the game;
c) causing the three dimensional object to morph so that all faces of said three dimensional object fragment then re assemble on the display screen in two dimensions;
d) forming at least one pay line which traverses a path of symbols;
e) awarding a player according to a comparison between the symbols traversed by said at least one pay line and the predetermined pay table.

29. A method of playing an electronic game, comprising the steps of
a) providing a screen display comprising at least one three dimensional object having a plurality of faces,
b) making a wager on an outcome of the game;
c) effecting a spin command to cause one or more said objects to morph by fragmentation of each said faces of said at least one object thereby forming rows and/or columns bearing symbols, one on each face;
d) providing at least one pay line for a player from traversing symbols on said rows and/or columns formed by said morphing; and
e) comparing the symbols traversed by said at least one pay line with a predetermined pay table.

30. A method of playing an electronic game on a slot machine gaming machine, or computer; wherein the method comprises the steps of,
a) presenting on a screen in three dimensions an object having a plurality of faces which each include a symbol, icon, number or the like;
b) making a wager on an outcome of the game;
c) effecting a spin command to cause one or more said objects responsive to said spin command to re orient the faces to form a plurality of two dimensional rows and/or columns formed by the symbols such that the number of symbols in the rows and columns corresponds to a number of hidden and/or exposed faces on a corresponding three dimensional object;
d) comparing symbol combinations traversed by pay lines with a pay table to determine an award to a player on the game outcome.

31. A method according to claim 30 comprising the further step before presenting the three dimensional object on the screen display, of initially presenting on the screen an opened out two dimensional array wherein the array comprises discrete symbol carriers which have a surface on which a symbol is displayed; wherein, the discrete symbol carriers combine to form the three dimensional object during morphing from the initial two dimensional display to the three dimensional display.

32. An electronic game for play on a display screen wherein the game comprises;
a display background,
a two dimensional display of discrete elements each having a surface capable of holding a symbol;
means associated with the game to initiate game play; wherein, when game play is initiated, the two dimensional display of discrete elements morph to cause at least one three dimensional object to be presented on the display having at least one exposed surface defining a wall of the object;
wherein, during game play, said at least one three dimensional object morphs from three dimensions to form a two dimensional display of plurality of symbols.

33. An electronic game according to claim 32 wherein each said symbol of the two dimensional display is displayed on a symbol carrier wherein each symbol carrier forms at least part of said at least one three dimensional object.

34. An electronic game according to claim 32 wherein said morphing involves fragmentation of inner and/or outer surfaces of the three dimensional object and reformation of said surfaces in a two dimensional array of symbol carriers.

35. An electronic game according to claim 34 wherein said fragmentation of the three dimensional objects forms discrete elements each having a surface which bears at least one symbol.

36. An electronic game according to claim 35 wherein the discrete elements assemble to form at least one row of symbol carriers.

37. An electronic game according to claim 36 wherein a surface of each discrete element forms part of an inner surface of the three dimensional object and an opposite surface of each discrete element forms part of an external surface of the object.

38. An electronic game according to claim 37 wherein, the total surface area of the symbol carriers displayed in two dimensions is equal the total surface area of either an internal or external surface of the at least one three dimensional object.

39. An electronic game according to claim 38 wherein the display of the symbols on the symbol carriers and the symbols carriers is random.

40. An electronic game according to claim 39 wherein there are a plurality of hidden internal surfaces in each said three dimensional object.

41. An electronic game according to claim 32, wherein, the typical game has an additional feature whereby a predetermined event during an initial game play will trigger a second game state and a number of subsequent game states.
